(19) United States
(12) Patent Application Publication
(10) Pub. No.: US 2011/0229254 A1
(43) Pub. Date: Sep. 22, 2011

(54) TOOL JOINT STRUCTURE

(76) Inventor: Cheng-Wei SU, Taichung City (TW)

(21) Appl. No.: 13/048,879

(22) Filed: Mar. 16, 2011

(30) Foreign Application Priority Data
Mar. 19, 2010 (TW) 099108102

(51) Int. Cl. F16C 11/06

(52) U.S. Cl. 403/114

(57) ABSTRACT

A tool joint structure capable of being connected to a drive tool and a socket comprises a body, a pressing assembly, a rod element and a positioning element. The respective components of the tool joint structures can be fixed by the positioning element in an insertion-pressing manner, thus reducing the assembly cost of the tool joint structure.

### BACKGROUND OF THE INVENTION

1. Field of the Invention

The present invention relates to a tool capable of being adjusted to various working angle, and more particularly to a tool joint structure.

2. Description of the Prior Art

A conventional universal tool joint structure comprises a cylinder-shaped master seat formed with a rectangular engaging hole in a first end thereof, and a second end of the master seat includes a round connecting hole. The connecting hole includes a through hole penetrating a side wall thereof. The master seat is further formed in an inner surface of the connecting hole with an accommodation groove opposite the through hole. In an inner bottom of the connecting hole of the master spring is disposed a compress spring, and a pivot ball outside the compress spring. The pivot ball is a first end of a joint, and a second end of the joint is a rectangular engaging portion. Furthermore, the pivot ball includes two penetration holes penetrating two opposite sides thereof. A first end of a bolt is inserted through the penetration holes of the pivot ball from the through hole of the master seat and then presses against the accommodation groove of the master seat, and a second end of the bolt is slightly depressed in the outer surface of the through hole and fixed in the through hole by welding and finally ground flush.

The through hole is sealed by welding, but in the manufacturing process, since the universal tool joint structure has an excessively small volume and needs to be subjected to welding operation and grinding operation, the assembly of the universal tool joint structure costs lots of time and requires much labor, thus increasing the assembly cost.

The present invention has arisen to mitigate and/or obviate the afore-described disadvantages.

### SUMMARY OF THE INVENTION

The primary objective of the present invention is to provide a tool joint structure which can reduce the assembly cost by assembling the positioning element in an insertion-pressing manner to fix the respective components.

Hence, to achieve the above objective, a tool joint structure in accordance with the present invention comprises a body, a pushing assembly, a rod element, and a positioning element.

The body includes an engaging portion and a pivoting portion at both ends thereof. The engaging portion is engaged on the drive tool, and the pivoting portion is formed with a pivoting groove. The pivoting groove includes a receiving groove in a bottom surface thereof and is further formed with two limiting grooves in an inner peripheral surface thereof, and an insertion hole between the two limiting grooves;

The pressing assembly is compressibly disposed in the receiving groove;

The rod element includes a working portion and a ball portion at both ends thereof. The working portion is adapted for engagement with the socket, and the ball portion includes a ball center and a bolt. Both ends of the bolt protrude out of an outer peripheral surface of the ball portion, and the ball portion is pivoted in the pivoting groove of the body in such a manner that the pressing assembly presses against the outer peripheral surface of the ball portion. The ball center is located closer to the bottom surface of the pivoting groove than the insertion hole, and the two ends of the bolt are disposed in the limiting grooves of the pivoting groove, respectively.

The positioning element includes a pressing portion and is inserted in the insertion hole of the body. The pressing portion of the positioning element presses against the outer peripheral surface of the ball portion for preventing the rod element from disengaging from the body.

### BRIEF DESCRIPTION OF THE DRAWINGS

FIG. 1 is an exploded view of a tool joint structure in accordance with the present invention;

FIG. 2 is a perspective view of the tool joint structure in accordance with the present invention;

FIG. 3 is a first cross-sectional view of the tool joint structure in accordance with the present invention;

FIG. 4 is a second cross-sectional view of the tool joint structure in accordance with the present invention;

FIG. 5 is a first operational state view of the tool joint structure in accordance with the present invention;

FIG. 6 is a second operational state view of the tool joint structure in accordance with the present invention;

FIG. 7 is a third cross-sectional view, showing the bolt is integrally formed on the ball portion of the rod element in accordance with the present invention;

FIG. 8 is a cross-sectional view of another tool joint structure in accordance with the present invention;

FIG. 9 is an exploded view of another tool joint structure in accordance with the present invention; and

FIG. 10 is a cross-sectional view of FIG. 9.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

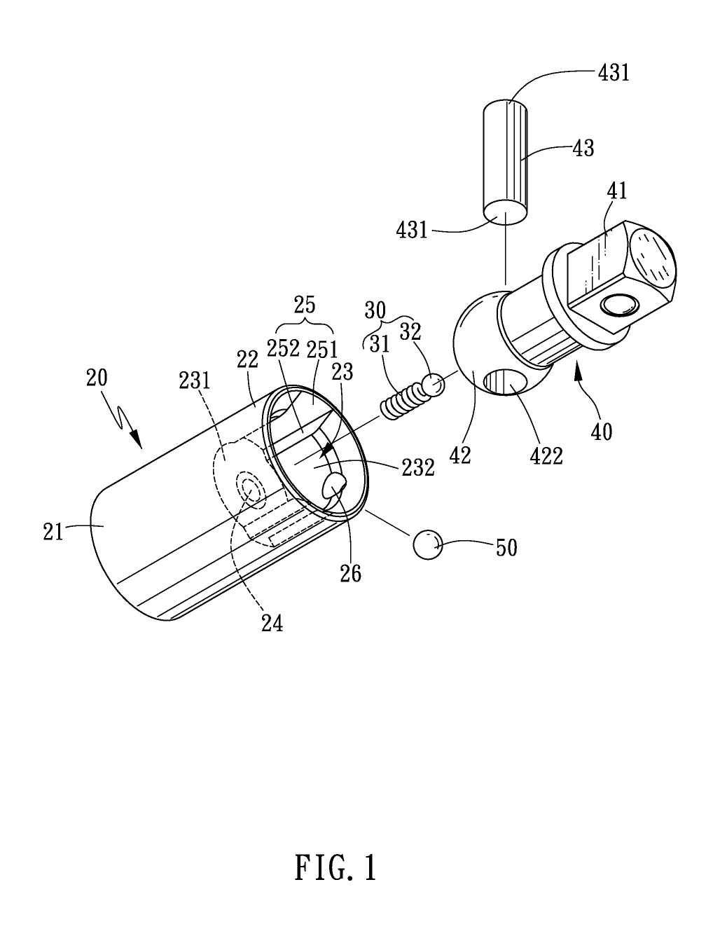

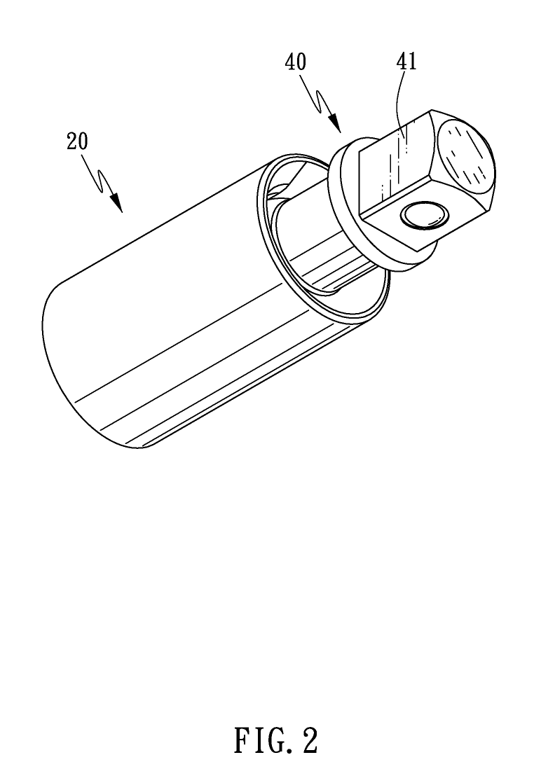

Referring to FIGS. 1-4, the present invention provides a tool joint structure that can be connected to a drive tool 11 and a socket 12. The tool joint structure in a first embodiment of the present invention comprises a body 20, a pressing assembly 30, a rod element 40 and a positioning element 50.

The body 20 includes an engaging portion 21 and a pivoting portion 22 at both ends thereof. The engaging portion 21 includes an engaging groove 211 to be engaged on the drive tool 11. The pivoting portion 22 is formed with a pivoting groove 23 in an axial direction of the body 20. The pivoting groove 23 includes a receiving groove 24 in a bottom surface 231 thereof. The pivoting groove 23 is formed with two limiting grooves 25 in an inner peripheral surface 232 thereof in the axial direction of the body 20. The respective limiting grooves 25 are defined by a bottom surface 251 and two side surfaces 252 connected at both ends of the bottom surface 251. Furthermore, the pivoting groove 23 is formed in the inner peripheral surface 232 with an insertion hole 26 between the two limiting grooves 25, and the insertion hole 26 is located adjacent to an opening of the pivoting groove 23.

The pressing assembly 30 is compressibly disposed in the receiving groove 24 of the body. In the present embodiment, the pressing assembly 30 includes a spring 31 and a steel ball 32 constantly pushed toward the opening of the receiving groove 24 by the spring 31.

The rod element 40 includes a working portion 41 and a ball portion 42 at both ends thereof. The working portion 41 is adapted for engagement with the socket 12. The ball portion 42 includes a ball center 421 and an insertion hole 422 for insertion of a bolt 43. The bolt 43 has both ends 431 protruding out of an outer peripheral surface 423 of the ball portion 42. Each of the two ends 431 of the bolt 43 has a curved end surface. The ball portion 42 is pivoted in the pivoting groove 23 of the body 20 in such a manner that the steel ball 32 presses against the outer peripheral surface 423 of the ball portion 42, and the ball center 421 is located closer to the bottom surface 231 of the pivoting groove 23 than the insertion hole 422.

The positioning element 50 is in the form of a ball and includes a pressing portion 51. The positioning element 50 is inserted into the insertion hole 26 of the body 20, and the pressing portion 51 presses against the outer peripheral surface 423 of the ball portion 42 for preventing the rod element 40 from disengaging from the body 20.

The aforementioned is the summary of the positional and structural relationship of the respective components of the preferred embodiment in accordance with the present invention.

Thereby, after the pressing assembly 30 and the rod element 40 are assembled to the pivoting portion 22, the positioning element 50 will be inserted into the insertion hole 26 of the pivoting portion 22 with the pressing portion 51 pressing against the outer peripheral surface 423 of the ball portion 42 of the rod element 40, thus finishing the assembly of the tool joint structure of the present invention. Therefore, it can be found that the respective components of the tool joint structure in accordance with the present invention can be fixed by assembling the positioning element 50 in an insertion-pressing manner, thus reducing the assembly cost of the present invention.

It is to be noted that, since the ball center 421 of the ball portion 42 is located closer to the bottom surface 231 of the pivoting groove 23 than the insertion hole 26, and the positioning element 50 is inserted in the insertion hole 26, the positioning element 50 presses against a tapered portion of the outer peripheral surface 423 of the ball portion 42, which is located adjacent to the working portion 41 of the rod element 40. Therefore, the positioning element 50 can prevent the rod element 40 from disengaging from the body 20.

In addition, the angle of the rod element 40 with respect to the body 20 of the tool joint structure in accordance with the present invention can be adjusted in two directions:

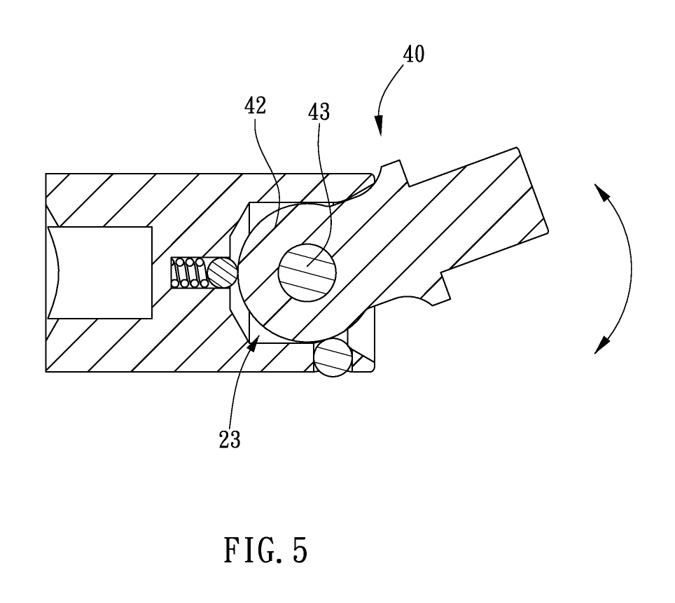

Firstly, referring to FIGS. 1, 3, and 5, since the ball portion 42 of the rod element 40 is pivoted in the pivoting groove 23 through the bolt 43, and the two ends 431 of the bolt 43 are limited by the side surfaces 252 of the two limiting grooves 25, hence, the rod element 40 is allowed to pivot around the bolt 43, thus adjusting the angle between the rod element 40 and the body 20 in a first direction.

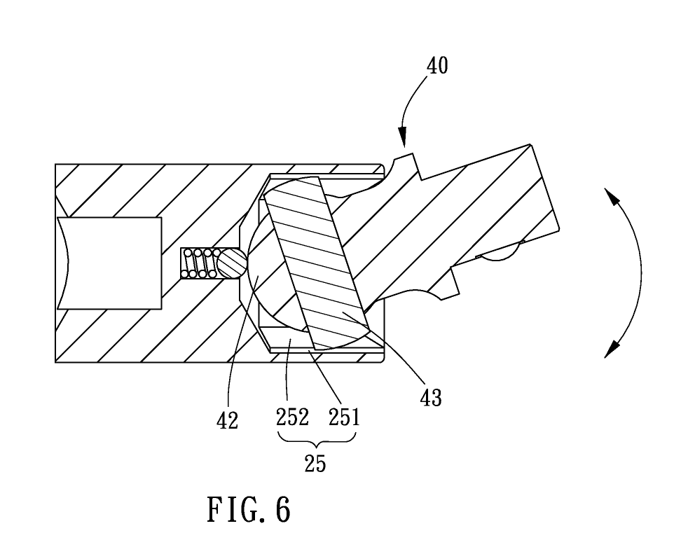

Secondly, referring to FIGS. 1, 4 and 6, since the bolt 43 disposed in the ball portion 42 of the rod element 40 is only limited by the side surfaces 252 of the limiting grooves 25 of the body 20, hence, the rod element 40 is allowed to pivot toward the bottom surfaces 251 of the two limiting grooves 25, thus adjusting the angle between the rod element 40 and the body 20 in a second direction.

It is to be noted that, when being adjusted in one of the two directions, the angle between the rod element 40 and the body 20 can also be synchronously adjusted the other of the two directions, further enhancing the applicability of the tool joint structure in accordance with the present invention.

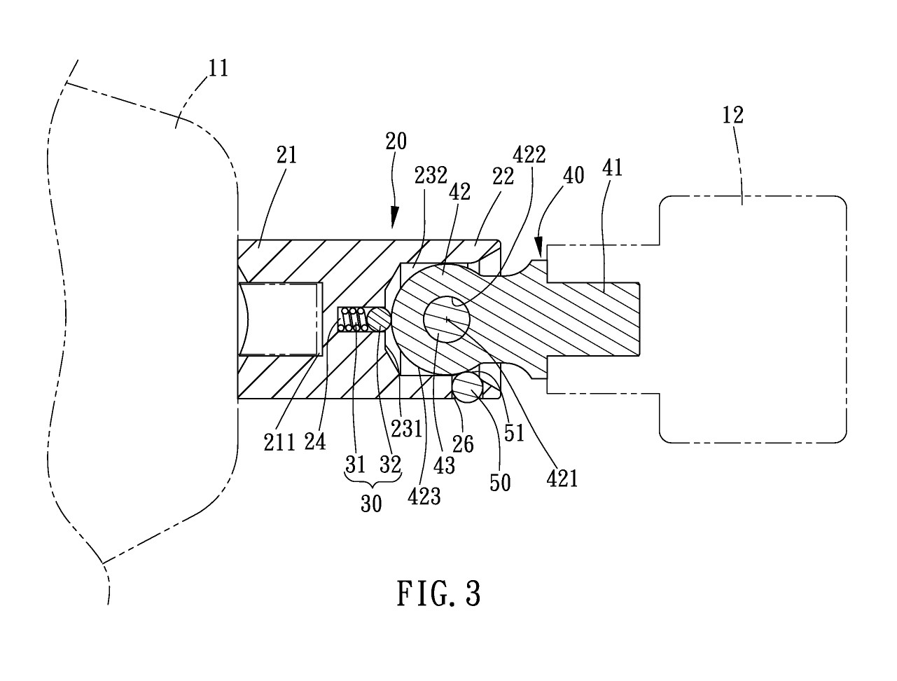

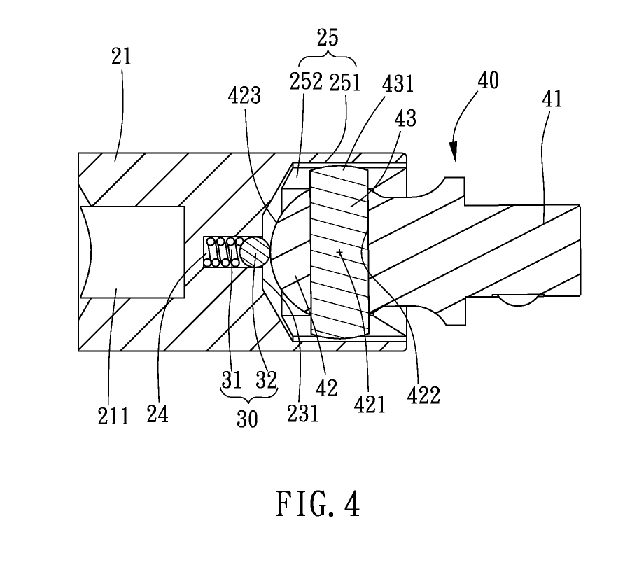

The present invention can further enhance the operation smoothness of the tool joint structure. Referring to FIGS. 3 and 4, since the pressing assembly 30 is disposed between the body 20 and the rod element 40 with its steel ball 32 pressing against the ball portion 42 of the rod element 40, hence, the ball portion 42 can produce a pressing force toward the opening of the pivoting groove 23 of the body 20. In addition, since the ball portion 42 of the rod element 40 is limited by the positioning element 50 and cannot disengage from the pivoting groove 23 of the body 20, hence, the angle of the rod element 40 is difficult to change after being adjusted.

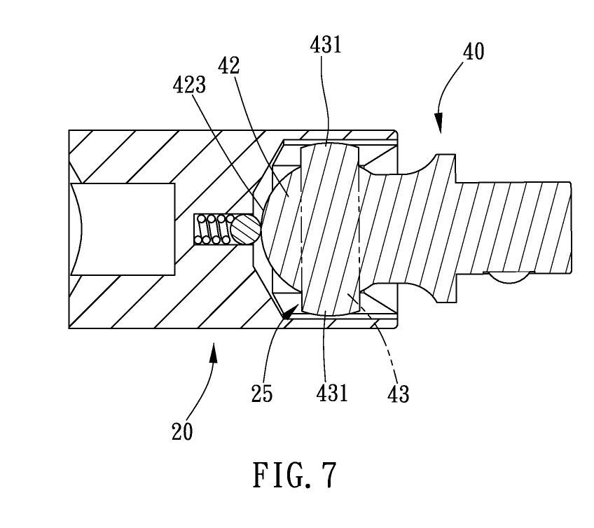

Referring to FIG. 7, preferably, the present invention provides a tool joint structure in accordance with a second embodiment in which a bolt 43 is integrally formed on the ball portion 42 of the rod element 40 and has both ends 431 directly protruding out of the outer peripheral surface 423 of the ball portion 42. The two ends 431 are disposed in the two limiting grooves 25 of the body 20 in the same manner.

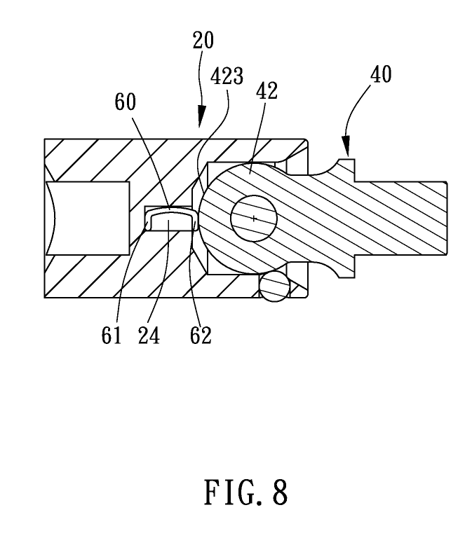

Referring to FIG. 8, besides including the spring and the steel ball, the pressing assembly in accordance with the present invention can also be an elastic sheet 60. The elastic sheet 60 includes a bottom portion 61 pressing against a bottom surface of the receiving groove 24, and a pressing portion 62 pressing against the outer peripheral surface 423 of the ball portion 42 of the rod element 40.

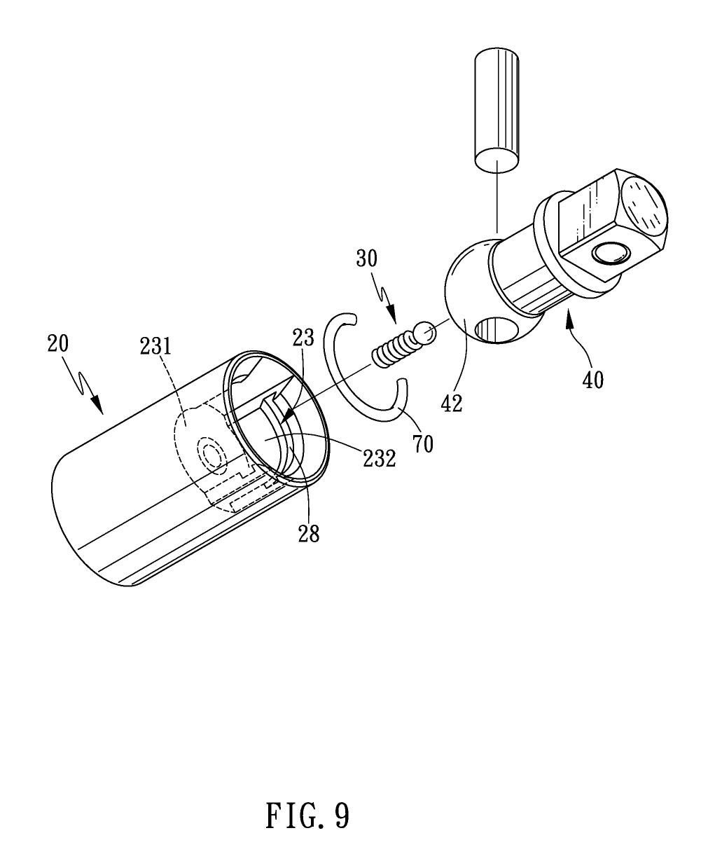

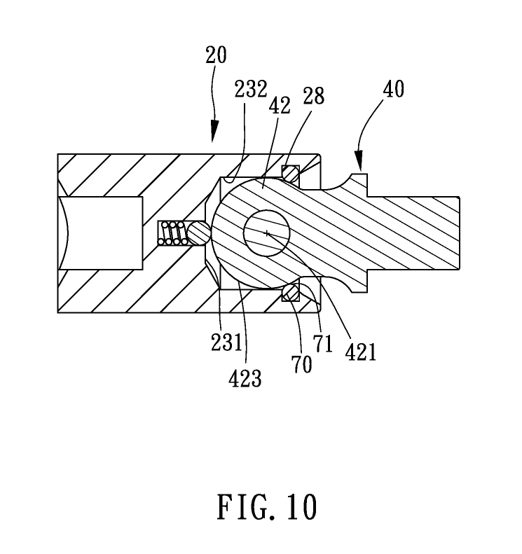

Finally, referring to FIGS. 9 and 10, the present invention provides a tool joint structure in accordance with a third embodiment which also comprises the body 20, the pressing assembly 30, the rod element 40, and a positioning element 70. Its configuration and function are the same as the above embodiment, so no further explanation is provided herein, but the difference of the present embodiment is described as follows:

The inner peripheral surface 232 of the pivoting groove 23 of the body 20 is formed with a curved groove 27 for accommodation of the positioning element 70. The positioning element 70 is a C-shaped buckle and includes a pressing portion 71 pressing against the outer peripheral surface 423 of the ball portion 42, preventing the rod element 40 from disengaging from the body 20. The ball center 421 of the ball portion 42 of the rod element 40 is located closer to the bottom surface 231 of the pivoting groove 23 than the curved groove 27.

The aforementioned is the summary of the positional and structural relationship of the respective components of the preferred embodiment in accordance with the present invention.

For a better understanding of the present invention, its operation and function, reference should be made to FIG. 3:

While we have shown and described various embodiments in accordance with the present invention, it is clear to those skilled in the art that further embodiments may be made without departing from the scope of the present invention.

What is claimed is:

1. A tool joint structure adapted to be connected to a drive tool and a socket, comprising:
a body including an engaging portion and a pivoting portion at both ends thereof, the engaging portion being engaged on the drive tool, the pivoting portion being formed with a pivoting groove, the pivoting groove including a receiving groove in a bottom surface thereof, the pivoting groove being further formed with two limiting grooves in an inner peripheral surface thereof, and an insertion hole between the two limiting grooves;
a pressing assembly being compressibly disposed in the receiving groove;
a rod element including a working portion and a ball portion at both ends thereof, the working portion being adapted for engagement with the socket, the ball portion including a ball center and a bolt, both ends of the bolt protruding out of an outer peripheral surface of the ball portion, the ball portion being pivoted in the pivoting groove of the body in such a manner that the pressing assembly presses against the outer peripheral surface of the ball portion, the ball center being located closer to the bottom surface of the pivoting groove than the insertion hole, the two ends of the bolt being disposed in the limiting grooves of the pivoting groove, respectively; and
a positioning element including a pressing portion and being inserted in the insertion hole of the body, the pressing portion of the positioning element pressing against the outer peripheral surface of the ball portion for preventing the rod element from disengaging from the body.

2. The tool joint structure as claimed in claim 1, wherein the limiting grooves are formed in an axial direction of the body.

3. The tool joint structure as claimed in claim 2, wherein the respective limiting grooves are defined by a bottom surface and two side surfaces connected at both ends of the bottom surface thereof.

4. The tool joint structure as claimed in claim 1, wherein each of the two ends of the bolt includes a curved end surface.

5. The tool joint structure as claimed in claim 1, wherein the bolt is integrally formed on the ball portion of the rod element.

6. The tool joint structure as claimed in claim 1, wherein the pressing assembly is disposed in the receiving groove of the first rod and includes a spring and a steel ball pushed toward the opening of the receiving groove by the spring and pressing against the outer peripheral surface of the ball portion of the rod element.

7. The tool joint structure as claimed in claim 1, wherein the pressing assembly is an elastic sheet, the elastic sheet includes a bottom portion pressing against a bottom surface of the receiving groove, and a pressing portion pressing against the outer peripheral surface of the ball portion of the rod element.

8. A tool joint structure adapted to be connected to a drive tool and a socket, comprising:
a body including an engaging portion and a pivoting portion at both ends thereof, the engaging portion being engaged on the drive tool, the pivoting portion being formed with a pivoting groove, the pivoting groove including a receiving groove in a bottom surface thereof, the pivoting groove being further formed with two limiting grooves and a curved groove in an inner peripheral surface thereof;
a pressing assembly being compressibly disposed in the receiving groove;
a rod element including a working portion and a ball portion at both ends thereof, the working portion being adapted for engagement with the socket, the ball portion including a ball center and a bolt, both ends of the bolt protruding out of an outer peripheral surface of the ball portion, the ball portion being pivoted in the pivoting groove of the body in such a manner that the pressing assembly presses against the outer peripheral surface of the ball portion, the ball center being located closer to the bottom surface of the pivoting groove than the curved groove, the two ends of the bolt being disposed in the limiting grooves of the pivoting groove, respectively; and
a positioning element including a pressing portion and being inserted in the curved groove of the body, the positioning element pressing against the outer peripheral surface of the ball portion for preventing the rod element from disengaging from the body.
